(19) United States
(12) Patent Application Publication
(10) Pub. No.: US 2020/0400508 A1
(43) Pub. Date: Dec. 24, 2020

(54) Self-Heating Thermal Dispersion Sensor System

(71) Applicant: ANALYSIS AND MEASUREMENT SERVICES CORPORATION, Knoxville, TN (US)

(72) Inventors: Alexander Hashem Hashemian, Knoxville, TN (US); Shawn Nathan Tyler, Knoxville, TN (US); Adam Sterling Deatherage, Knoxville, TN (US)

(21) Appl. No.: 16/911,032

(22) Filed: Jun. 24, 2020

Related U.S. Application Data
(60) Provisional application No. 62/865,673, filed on Jun. 24, 2019.

(51) Int. Cl. G01K 7/20; G01K 13/02; G01K 1/02; G01F 1/69; G01F 23/24

(52) U.S. Cl. CPC G01K 7/20; G01K 13/02; G01F 23/246; G01F 1/69; G01K 1/024

(57) ABSTRACT

A sensor system including a sensor probe configured to house one or more coils of resistive electrical wire, an electrical circuit configured to energize each coil so as generate heat within the sensor probe and receive output signals from each coil, the sensor probe comprising a heat transfer material designed to facilitate heat transfer between the sensor probe and a surrounding medium surrounding the sensor probe, and a processing unit configured to measure the output signals from each coil to determine changes in level, temperature, and/or flow rate of the surrounding medium based on changes in the output signals.

### CROSS-REFERENCE TO RELATED APPLICATIONS

This application claims the benefit of U.S. Provisional Application No. 62/865,673 filed on Jun. 24, 2019, the disclosure of which is incorporated by reference herein in its entirety.

### STATEMENT OF GOVERNMENT INTEREST

This invention was made with government support under contract number DE-SC0011859 awarded by the U.S. Department of Energy. The government has certain rights in the invention.

### BACKGROUND

The present general inventive concept relates to a sensor system for measurement of level, temperature, and/or flow rate.

For many industrial plant applications, level, temperature, and flow rate are critical process parameters used by the plant control and safety systems to safely and efficiently operate the plant. Level may be measured using differential pressure transmitters, ultrasonic sensors, guided-wave or through-air radar systems, capacitive sensors, laser systems, or other devices.

In addition, there are commercially available level switches that are based on the principle of thermal dispersion. A typical thermal dispersion level switch uses two small resistive elements, such as two platinum resistance temperature detectors (RTDs), located at the tip of the sensor. One of the RTDs is heated above the surrounding process temperature while the other RTD is maintained at the surrounding process temperature and used as a reference. If both RTDs are exposed to air or another gas which is a poor heat transfer medium, the heated RTD is unable to dissipate its heat effectively to the surroundings, and the temperature difference between the two RTDs is relatively large. If both RTDs are submerged in water or another liquid which is a good heat transfer medium, the heated RTD is able to dissipate its heat effectively to the surroundings, and the temperature difference between the two RTDs is relatively small. The sensor electronics sample and analyze the RTD data to determine whether or not the elements are submerged. This type of thermal dispersion level sensor can only provide a discrete level measurement at a single point and cannot provide continuous level measurement. Other thermal dispersion sensor systems may utilize multiple discrete point sensors to measure level. However, this type of system has a step function output with poor measurement resolution. In addition, each discrete point sensor requires wires that connect to the sensing element which can be overly complex and expensive.

Similarly, temperature is commonly measured using point sensors such as thermocouples or RTDs. Bulk fluid temperature measurement may be made by averaging the output signals from several thermocouples or RTDs installed at various locations in the process.

Flow rate may be measured using differential pressure transmitters, ultrasonic flow meters, turbine flow meters, pitot tubes, anemometers, or other devices. However, these technologies have specific limitations to implementation and are generally used in circular piping.

To address these shortcomings, there are sensors that contain one or more continuous RTDs capable of sensing over an extended length similar to the sensor probe design described in the present invention. However, those sensors typically utilize one or more pairs of RTD elements (i.e. a sensing element and a heater element or reference element) as opposed to a single self-heated sensing element.

Therefore, what is desired is an improved thermal dispersion sensor system that can provide fast and continuous high-resolution measurement of level, temperature, and/or flow rate as well as important sensor data and diagnostic information in real-time.

### BRIEF SUMMARY

The present invention describes a thermal dispersion sensor system that enables continuous level, temperature, and flow rate measurement and provides valuable sensor data and diagnostic information in real-time.

Example embodiments of the present invention consists of a sensor probe that contains one or more long and continuous coils of resistive electrical wire that can be made to any specified length or shape and consist of any materials. The sensing wire coil may have a uniform turn density along its entire length for consistent measurement sensitivity or variable turn density for variable measurement sensitivity. The probe sheath encasing the sensing wire coil may be made of metal or plastic and may be coated with a protective film for use in harsh or corrosive environments. Within the probe, there may be insulation material such as aluminum oxide or magnesium oxide to protect and electrically insulate the sensing wire. The probe can be designed to facilitate heat transfer between the sensing wire and the surrounding process to ensure fast and sensitive sensor response to changes in the surrounding process. One or more additional electrically-isolated coils of wire within the probe may be used for redundancy and/or improved measurement accuracy.

The sensing wire within the probe is self-heated by current applied across its leadwires. The sensor is connected to an electrical circuit such as a Wheatstone bridge to enable continuous application of current to the sensing wire and simultaneous acquisition of the sensor output signal. The sensor output signal resolution is continuous and sensitive to changes in level, temperature, and flow rate. The sensor output signal may be sampled multiple times per second by a data acquisition device.

The data acquisition device receives the sensor output signal and processes the data to determine level, temperature, and/or flow rate. In addition, the sensor system is capable of online verification of sensor performance including its calibration and response time, trending the health of the sensing element wire through automatic periodic electrical tests such as inductance, capacitance, and resistance (LCR) measurements as well as time domain and frequency domain reflectometry (TDR/FDR), and identification of anomalies in the sensor or process such as foreign material buildup along the probe. The process data and sensor diagnostic information may be displayed and stored locally on the sensor itself via on-board electronics, displays, and storage devices and/or remotely in real-time via wired and/or wireless transmission to a host network or control system. The data acquisition and processing system may be used with similar thermal dispersion sensor technologies that contain one or more resistive sensing elements regardless of the shape, length, materials, etc. of the sensor probe.

### BRIEF DESCRIPTION OF THE DRAWINGS

The above-mentioned features of the present general inventive concept will become more clearly understood from the following detailed description of the invention read together with the drawings in which:

FIG. 1 is a diagram of the sensor system according to an exemplary embodiment of the present invention.

FIG. 2 is a block diagram illustrating the process of noise data acquisition.

FIG. 3 is a representation of the output signal produced as a result of process noise input to the sensor including a static component and a dynamic component.

FIG. 4 is an illustration of a theoretical PSD curve with break frequency according to an example embodiment of a noise analysis technique.

FIG. 5 is an illustration of the Loop Current Step Response (LCSR) test principle which involves the sudden application of electric current to the sensor to cause it to self-heat above the ambient. The resulting transient may be sampled and analyzed to determine sensor response time.

FIG. 6 is a representative graph of a time-domain reflectometry (TDR) trace for one embodiment of the thermal dispersion sensor of the present invention.

### DETAILED DESCRIPTION

The thermal dispersion sensor system according to example embodiments of the present general inventive concept are capable of fast and continuous high-resolution measurement of level, temperature, and/or flow rate. Example embodiments can include a sensor probe that contains one or more long and continuous coils of resistive electrical wire that can be made to any specified length or shape and consist of any materials. The sensing wire coil may have a uniform turn density along its entire length for consistent measurement sensitivity or variable turn density for variable measurement sensitivity. The probe sheath encasing the sensing wire coil may be made of metal or plastic or another material and may be coated with a protective film for use in harsh or corrosive environments. Within the probe, there may be insulation material such as aluminum oxide or magnesium oxide to protect and electrically insulate the sensing wire. The probe can be designed to facilitate heat transfer between the sensing wire and the surrounding process to ensure fast and sensitive sensor response to changes in the surrounding process. One or more secondary coils of wire within the probe and electrically isolated from the primary coil may be used for redundancy and/or improved measurement accuracy. When current is applied to the sensing wire, it self-heats via Joule heating, and the heat dissipates to the surroundings. Changes in fluid level, temperature, and flow rate affect this heat transfer as well as the effective electrical resistance of the sensing wire which can be measured using an electrical circuit such as a Wheatstone bridge. The bridge circuit enables continuous application of current to the sensing wire and simultaneous acquisition of the sensor output signal. A data acquisition device receives the sensor output signal and processes the data to determine level, temperature, and/or flow rate.

The sensor output signal may be sampled multiple times per second by the data acquisition device and analyzed automatically using the noise analysis technique. The noise analysis technique is a passive sensor response time test that is based on monitoring the natural fluctuations that exist at the output of a sensor while it is measuring a dynamic process. These fluctuations, or process noise, may be due to flow induced turbulence, random heat transfer, or other naturally occurring phenomena. The noise data is analyzed in the frequency domain by generating a power spectral density (PSD) of the signal via a Fast Fourier Transform (FFT) algorithm and fitting a mathematical function to the PSD to yield parameters that are used to determine sensor response time. Autoregressive (AR) modeling, a time domain technique, may also be used in addition or in lieu of frequency domain analysis via FFT. The performance of this analysis may be facilitated by the use of specialized software packages. The noise analysis technique can be utilized to measure the in-situ response time of the sensor and to identify physical anomalies in the sensor probe that may compromise its dynamic performance and/or functionality over time. This is especially true if the sensor probe is installed in harsh or corrosive environments.

The response time of the sensor may also be determined in-situ using the Loop Current Step Response (LCSR) test method. The LCSR test method involves applying a step change in electric current to the sensor and analyzing the resulting heating transient to obtain sensor response time. The LCSR method is an active test that can be performed using the same electrical bridge circuit that enables simultaneous self-heating of the sensing wire and output signal data acquisition. The LCSR method is best suited for measuring sensor response time in stagnant processes in which sufficient process fluctuations do not exist to drive the sensor output and enable the use of the noise analysis technique.

If the sensor probe consists of two or more sensing elements, online monitoring (OLM) technologies may be implemented to verify the sensor calibration in-situ. In addition, the sensor output signal may also be analyzed in conjunction with other sensors installed in the same process over time to determine if the calibration of the sensor has drifted. OLM involves collecting and analyzing the data from sensors while installed in a process to verify the performance of the sensors themselves or to identify anomalies in the process. In the event that the sensor has drifted, its calibration may be adjusted remotely and analytically.

Electrical test equipment may be incorporated into the on-board electronics of the sensor or utilized remotely to make automatic in-situ electrical test measurements on the sensing wire such as LCR measurements and insulation resistance (IR) measurements. LCR measurements characterize the health of the sensing wire. IR measurements characterize the health of the insulation material (e.g. aluminum oxide, magnesium oxide, etc.) within the probe. In addition, TDR and FDR technologies may be used for troubleshooting and identifying faults in the sensing wire. Reflectometry techniques such as TDR involve applying an electrical pulse to a circuit. Some of the pulse is reflected back to the source when it encounters changes in impedance along the circuit. The reflections may be plotted versus distance along the circuit to identify the locations of faults.

The data acquisition, signal processing, and electrical test systems may contain software packages to enable the end user to specify sensor parameters and review sensor data and diagnostics. The sensor system may store and display data locally on the sensor itself via on-board electronics, displays, and storage devices and/or remotely in real-time via wired and/or wireless transmission to a host network or control system.

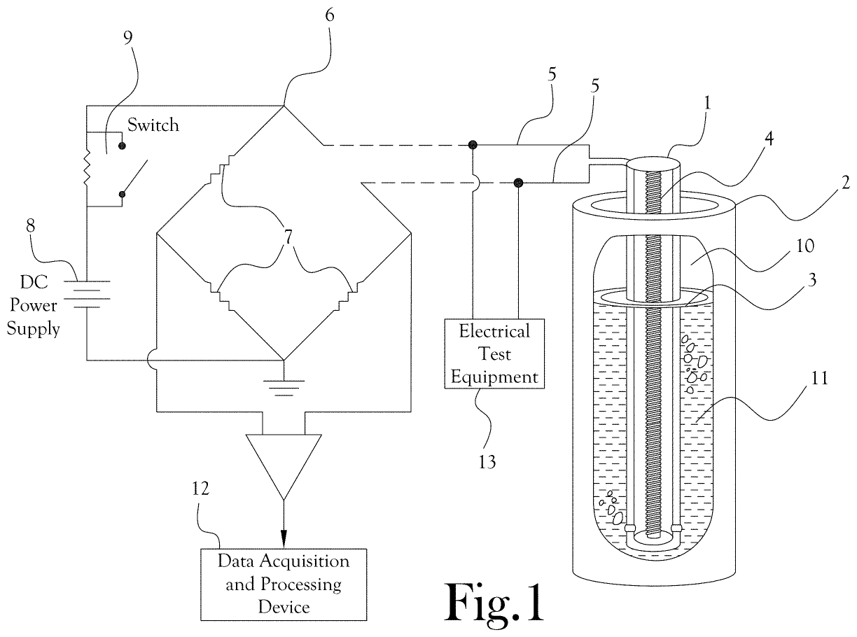

FIG. 1 illustrates one possible configuration of the sensor probe 1 as installed in a tank or vessel 2 to measure fluid level 3. The probe 1 contains a continuous coil of resistive electrical wire 4 that spans the complete length of the probe 1. The leadwires 5 of the probe 1 are connected to a leg of an electrical bridge circuit 6 with three other resistors 7 and a direct current (DC) power supply 8. When the switch 9 is closed, electrical current flows through the bridge circuit 6 and also through the leadwires 5 of the probe 1. This flow of current results in the wire 4 self-heating above the ambient temperature. The effective electrical resistance of the wire 4 is a function of its ability to dissipate heat to its surroundings. When the probe 1 is in a gas such as air 10, the wire 4 cannot effectively dissipate heat to the air 10, because air 10 acts as an insulator. In this case, the electrical resistance of the wire 4 increases. When the probe 1 is submerged in liquid such as water 11, the wire 4 can dissipate heat to the water 11 more effectively, because heat transfer through water 11 is much greater than that through air 10. In this case, the electrical resistance of the wire 4 decreases. Changes in the electrical resistance of the wire 4 result in a voltage across the electrical bridge circuit 6. This voltage output signal can be received by a data acquisition device 12 to process the signal and determine level, temperature, and/or flow. The data acquisition device 12 may include software packages to analyze the data and obtain diagnostic information from the sensor. The data acquisition device 12 may store the data locally and/or transmit the data either via wired and/or wireless transmission to another system. For periodic electrical tests, the leadwires 5 of the probe 1 may also be connected to electrical test equipment 13 in order to perform LCR, IR, TDR, and/or FDR measurements on the wire 4. The electrical test equipment 13 may be incorporated with the data acquisition device 12 in the same physical assembly or located remotely.

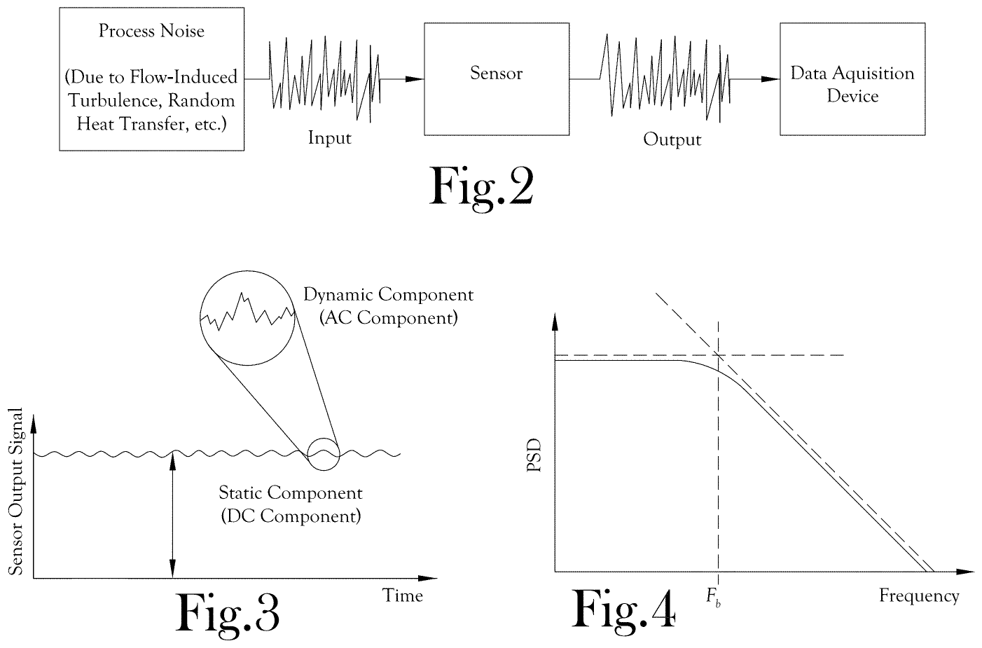

FIGS. 2 through 4 illustrate noise analysis. FIG. 2 is a block diagram illustrating the process of noise data acquisition. Noise from the process associated with random flow-induced turbulence or heat transfer or other phenomena is the dynamic input to the sensor. The resulting sensor output signal may be sampled at a fast rate and analyzed in the time and/or frequency domain. FIG. 3 is a representation of the output signal produced as a result of process noise input to the sensor including a static and dynamic component which contains fluctuations or process noise important to the determination of sensor response time or other important diagnostic information. The static component of the sensor output signal can be removed through the use of a high-pass filter or bias, leaving only the dynamic or noise component of the signal. The noise component is then amplified and passed through a low-pass filter to eliminate undesirable high-frequency electrical noise from the signal. Once the signal has been properly conditioned as described, time and/or frequency domain noise analysis techniques may be implemented. FIG. 4 is an illustration of a theoretical PSD curve with break frequency according to an example embodiment of a noise analysis technique. The PSD curve may be generated from the resulting sensor output signal sampled at a fast rate via FFT algorithms and identifying break frequency or fitting a mathematical function to the PSD may be used to determine the sensor response time or other diagnostic information. For a simple first-order system, the break frequency identified from the PSD is all that is needed to determine sensor response time. The break frequency is the intersection of a line which forms the flat portion of the PSD curve with a line which follows the slope of the trailing portion. The simple representative PSD provided in FIG. 4 does not show any resonances or other process effects that may affect the response time determination or may be indicative of important diagnostic information about the sensor and/or the process.

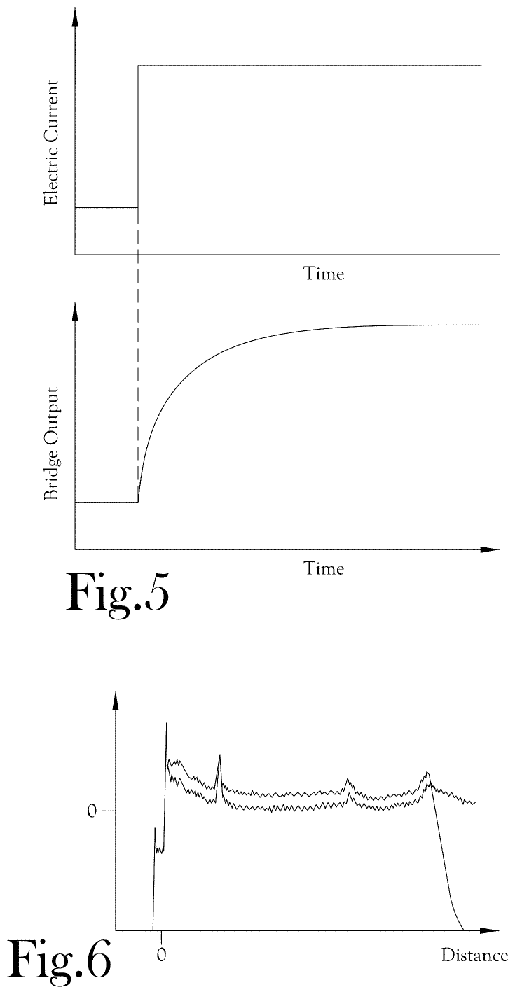

FIG. 5 is an illustration of the Loop Current Step Response (LCSR) test principle which involves the sudden application of electric current to the sensor to cause it to self-heat above the ambient. The resulting transient may be sampled and analyzed to determine sensor response time. The electrical bridge circuit 6 illustrated in FIG. 1 may facilitate both the application of the electric current required to self-heat the sensor as well as the sampling of the resulting bridge output signal which may be analyzed to determine sensor response time and/or provide insight into other phenomena.

FIG. 6 is a representative graph of a time-domain reflectometry (TDR) trace for one embodiment of the thermal dispersion sensor of the present invention. The TDR trace is plotted as a reflection coefficient versus distance from the test point made at the point in which the electrical test equipment 13 illustrated in FIG. 1 is connected to the sensor leadwires. The spikes and features of a TDR trace can be analyzed to identify anomalies along the length of the leadwires and through to the sensing element of the sensor. In general, a discontinuity along the length of the leadwires will result in a spike along a TDR trace, and a short will result in a drop along a TDR trace. The present invention provides a simple and cost-effective alternative to discrete sensors and switches that are based on the principle of thermal dispersion.

The present invention enables fast and continuous high-resolution measurement of level, temperature, and/or flow rate using a self-heated sensor probe that can be made to withstand harsh process conditions and designed to accommodate various installation geometries. The proposed sensor system includes in-situ test technologies that can be used with similar thermal dispersion sensor probe designs that contain one or more resistive sensing elements regardless of the shape, length, materials, etc. of the sensor probe and thus improve the functionality of the sensor technology.

The present invention enables: in-situ sensor response time measurement using the noise analysis technique and/or LCSR test method, in-situ sensor calibration verification using OLM technologies, health monitoring of the sensing wire and insulation material within the probe using LCR and IR measurements, and sensing wire fault finding using TDR and FDR technologies.

As illustrated and described herein, example embodiments of the present general inventive concept can include a sensor probe housing having a long and continuous coil of resistive electrical wire capable of sensing changes in the surrounding medium over its entire length. The sensing wire can be energized and thus self-heated via Joule heating. The heat generated within the probe from the sensing wire can be dissipated to the surrounding medium (i.e. fluid). Changes in fluid level, temperature, and flow rate affect this heat transfer as well as the effective electrical resistance of the sensing wire which can be measured directly and continuously using an electrical circuit such as a Wheatstone bridge. The leadwires of the probe can be connected to the bridge circuit, and the corresponding voltage output sent to a data acquisition device to process and analyze the sensor data. In addition to calculating level, temperature, and flow rate, the system is capable of in-situ verification of sensor performance including calibration and response time, trending the health of the sensing wire through automatic periodic electrical tests, and identification of anomalies in the sensor or process such as foreign material buildup along the probe. The process data and sensor diagnostic information may be displayed and stored locally on the sensor system and/or remotely in real-time via wired and/or wireless transmission to a host network or control system.

The data acquisition and processing system can be configured to collect fast and continuous high-resolution measurements and output sensor data and diagnostics. The proposed sensor system includes electrical test equipment capable of performing in-situ measurements on the sensing wire such as inductance, capacitance, and resistance (LCR) measurements as well as time domain and frequency domain reflectometry (TDR/FDR) to trend the health of the sensing wire and identify any degradation that may compromise sensor performance and/or functionality. The proposed sensor system can also sample data at frequency fast rate and analyze the data in the time and frequency domains to determine sensor response time and to identify anomalies in the sensor itself or the process. The proposed sensor system may be used with a self-heated probe as described herein or with similar sensor technologies that utilize one or more continuous RTDs, thus improving the functionality of existing sensors and furthering the state of the art.

As described herein, the systems, apparatus, methods, processes, control systems, functions, and/or operations and software for implementing the example embodiments of the present general inventive concept, for example the data acquisition and processing unit, may be wholly or partially implemented in the form of apparatus that includes processing elements and sets of executable instructions. The executable instructions may be part of one or more software applications and arranged into software architecture. In general, embodiments of the present general inventive concept may be implemented using a set of software instructions that are designed to be executed by a suitably programmed processing element (such as a central processing unit (CPU), GPU (graphics processing unit), microprocessor, processor, controller, computing device, etc.). In a complex application or system such instructions are typically arranged into “modules” with each such module typically performing a specific task, process, function, or operation. The entire set of modules may be controlled or coordinated in their operation by an operating system (OS) or other form of organizational platform.

The application modules may include any suitable computer executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language. The computer-executable code or set of instructions may be stored in (or on) any suitable non-transitory computer-readable medium. In general, with regards to the embodiments described herein, a non-transitory computer-readable medium may include almost any structure, technology or method apart from a transitory waveform or similar medium.

As described, the data acquisition and processing systems, apparatus, methods, processes, functions, software and/or operations for implementing the example embodiments of the present general inventive concept may be wholly or partially implemented in the form of a set of instructions executed by one or more programmed computer processors such as a central processing unit (CPU) or microprocessor. Such processors may be incorporated in the circuitry and components of an apparatus, server, client or other computing or data processing device operated by, or in communication with, other components of the system.

It should be understood that the modules or operations of the present invention as described and illustrated herein can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components, processes, modules, or functions described in this application may be implemented as software code to be executed by a processor using any suitable computer language such as, for example, Java, JavaScript, C++, LabVIEW or Perl using, for example, conventional or object-oriented techniques. The software code may be stored as a series of instructions, or commands in (or on) a non-transitory computer-readable medium, such as a random-access memory (RAM), a read only memory (ROM), a magnetic medium such as a hard-drive or a floppy disk, or an optical medium such as a CD-ROM. In this context, a non-transitory computer-readable medium is almost any medium suitable for the storage of data or an instruction set aside from a transitory waveform. Any such computer readable medium may reside on or within a single computational apparatus, and may be present on or within different computational apparatuses within a system or network.

According to some example implementations, the term data acquisition and processing unit and/or the test equipment can be referred to as a control system, processing unit, or processor, as used herein, which may be a central processing unit (CPU), or conceptualized as a CPU (such as a virtual machine). In such example implementation, the CPU or a device in which the CPU is incorporated may be coupled, connected, and/or in communication with one or more peripheral devices such as, but not limited to, an electrochemical impedance spectroscopy (EIS) measuring unit, as well as one or more displays. In other example implementations, the processing unit or processor may be incorporated into a mobile computing device, such as a smartphone or tablet computer.

The non-transitory computer-readable storage medium referred to herein may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, synchronous dynamic random access memory (SDRAM), or similar devices or other forms of memories based on similar technologies. Such computer readable storage media allow the processing element or processor to access computer-executable process steps, application programs and the like, stored on removable and non-removable memory media, to off-load data from a device or to upload data to a device. As mentioned, with regards to the embodiments described herein, a non-transitory computer-readable medium may include almost any structure, technology or method apart from a transitory waveform or similar medium.

Certain implementations of the disclosed technology are described herein with reference to block diagrams of systems, and/or to configurations, functions, processes, or methods. It will be understood that one or more of the configurations, methods, processes, and functions can be implemented by computer-executable program instructions. Note that in some embodiments, one or more of the configurations, methods, processes, systems, and functions may not necessarily need to be performed in a particular order, or may not necessarily need to be performed at all.

These computer-executable program instructions may be loaded onto a general-purpose computer, a special purpose computer, a processor, or other programmable data processing apparatus to produce a specific example of a machine, such that the instructions that are executed by the computer, processor, or other programmable data processing apparatus create means for implementing one or more of the functions, operations, processes, systems, or methods described herein.

These computer program instructions may also be stored in a computer-readable memory that can direct a computer or other programmable data processing apparatus to function in a specific manner, such that the instructions stored in the computer-readable memory produce an article of manufacture including instruction means that implement one or more of the functions, operations, processes, or methods described herein.

Numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated.

It is noted that the simplified diagrams and drawings included in the present application do not illustrate all the various connections and assemblies of the various components, however, those skilled in the art will understand how to implement such connections and assemblies, based on the illustrated components, figures, and descriptions provided herein, using sound engineering judgment.

1. A thermal dispersion sensor, comprising:
a sensor probe configured to house one or more coils of resistive electrical wire;
an electrical circuit configured to energize each coil so as generate heat within the sensor probe and receive output signals from each coil, the sensor probe comprising a heat transfer material designed to facilitate heat transfer between the sensor probe and a surrounding medium surrounding the sensor probe; and
a processing unit configured to measure the output signals from each coil to determine changes in level, temperature, and/or flow rate of the surrounding medium based on changes in the output signals.

2. The sensor of claim 1, wherein the electrical circuit is an electrical bridge circuit configured to connect to leadwires of each coil so as to provide an adjustable, continuous supply of electrical current to heat the resistive electrical wire of the sensor probe, the electrical bridge circuit being configured to measure output voltage signals corresponding to process parameters such as level, temperature, and/or flow rate via an LCSR test method

3. The sensor of claim 1, further comprising:
a data acquisition device configured to receive the output signals from the electrical circuit, the data acquisition unit being configured to process the output signals using noise analysis to verify sensor performance and identify anomalies in the sensor or process, to analyze the output signals over time to generate sensor data for comparison to baseline data to verify sensor calibration, to store and display the sensor data locally and/or remotely in real-time, and to transmit the data via wired and/or wireless transmission to a host network or control system.

4. The sensor of claim 1, further comprising an electrical test system configured to connect to leadwires of each coil to test the resistive electrical wire in situ using one or more of LCR, IR, TDR, and FDR measurements, to store test result data, to compare present test result data to baseline or historical data to identify trends in the test data, to display the electrical test data locally and/or remotely in real-time, and to transmit the electrical test data via wired and/or wireless transmission to a host network or control system.
